(19) United States
(12) Patent Application Publication
(10) Pub. No.: US 2026/0204595 A1
(43) Pub. Date: Jul. 16, 2026

(54) FUEL CELL

(71) Applicant: TOYOTA BOSHOKU KABUSHIKI KAISHA, Aichi-ken (JP)

(72) Inventors: Akihiro INUKAI, Okazaki-shi (JP); Kensuke DOI, Obu-shi (JP)

(73) Assignee: TOYOTA BOSHOKU KABUSHIKI KAISHA, Aichi-ken (JP)

(21) Appl. No.: 19/442,506

(22) Filed: Jan. 7, 2026

(30) Foreign Application Priority Data
Jan. 14, 2025 (JP) 2025-004742

(51) Int. Cl. H01M 8/0247; H01M 8/0297

(52) U.S. Cl. CPC H01M 8/0247; H01M 8/0297

(57) ABSTRACT

A fuel cell includes a cell stack, first and second end plates, first and second terminal plates, and first and second insulating plates. The first end plate is arranged on a first end of the cell stack in a stacking direction of the unit cells. The second end plate is arranged on a second end of the cell stack in the stacking direction. The first end plate, the first terminal plate, and the first insulating plate are stacked in the thickness direction. The second end plate, the second terminal plate, and the second insulating plate are stacked in the thickness direction. The first and the second terminal plate each include a terminal that projects outward from its outer edge. The first and the second insulating plate each include a projecting support that extends along one side of the terminal with respect to the thickness direction.

### CROSS-REFERENCE TO RELATED APPLICATIONS

This application is based upon and claims the benefit of priority from Japanese Patent Application No. 2025-004742, filed on January 14, 2025, the entire contents of which are incorporated herein by reference.

### BACKGROUND

### Field

The present disclosure relates to a fuel cell.

### Description of Related Art

JP2007-149392A discloses a fuel cell including a cell stack, first and second end plates, first and second terminal plates, and first and second insulating plates.

The cell stack is formed by stacking unit cells in a thickness direction. The first end plate is arranged at a first end of the cell stack in the stacking direction of the unit cells. The second end plate is arranged at a second end of the cell stack in the stacking direction of the unit cells. The first terminal plate is arranged between the first end plate and the first end of the cell stack in the stacking direction of the unit cells. The second terminal plate is arranged between the second end plate and the second end of the cell stack in the stacking direction of the unit cells. The first insulating plate is arranged between the first terminal plate and the first end plate. The second insulating plate is arranged between the second terminal plate and the second end plate. The first end plate, the first terminal plate, and the first insulating plate of the fuel cell are stacked in the thickness direction. The second end plate, the second terminal plate, and the second insulating plate of the fuel cell are stacked in the thickness direction.

Each unit cell of the cell stack includes a membrane electrode gas diffusion layer assembly. In the unit cell, electric power is generated from the reaction between fuel gas such as hydrogen, and oxidation gas such as air, in the membrane electrode gas diffusion layer assembly. The first and second terminal plates, which collect current from each unit cell of the cell stack, is formed from a conductive material such as metal. The first and the second terminal plates each include a terminal that projects outward from an outer edge of the terminal plate. A conductive wire configured to transfer electric power from the cell stack may be bolted to the terminal. The first insulating plate is configured to insulate the first terminal plate and the first end plate. The second insulating plate is configured to insulate the second terminal plate and the second end plate. The first and second insulating plates are formed from insulative material such as resin.

It is desirable that the thickness of the terminal plate be reduced to decrease the weight of the fuel cell. However, reduction of the thickness of the terminal plate reduces the thickness of the terminal. This decreases the rigidity of the terminal. When the rigidity of the terminal is decreased, the terminal may be deformed when the conductive wire is bolted to the terminal.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a fuel cell includes a cell stack, a first end plate, a second end plate, a first terminal plate, a second terminal plate, a first insulating plate, and a second insulating plate. The cell stack is formed by stacking unit cells in a thickness direction. The first end plate is arranged on a first end of the cell stack in a stacking direction of the unit cells. The second end plate is arranged on a second end of the cell stack in the stacking direction. The first terminal plate is arranged between the first end plate and the first end of the cell stack. The second terminal plate is arranged between the second end plate and the second end of the cell stack. The first insulating plate is arranged between the first terminal plate and the first end plate. The second insulating plate is arranged between the second terminal plate and the second end plate. The first end plate, the first terminal plate, and the first insulating plate are stacked in the thickness direction. The second end plate, the second terminal plate, and the second insulating plate are stacked in the thickness direction. The first terminal plate and the second terminal plate each include a terminal that projects outward from its outer edge and allows a conductive wire to be bolted thereto. The first insulating plate and the second insulating plate each include a projecting support that extends along one side of the terminal with respect to the thickness direction.

Other features and aspects will be apparent from the following detailed description, the drawings, and the claims.

### BRIEF DESCRIPTION OF THE DRAWINGS

FIG. 1 is a perspective view of a fuel cell.

FIG. 2 is a cross-sectional view showing a terminal of a first terminal plate in the fuel cell at a location corresponding to line II-II in FIG. 1.

FIG. 3 is a cross-sectional view showing a further example of how a conductive wire is bolted to a terminal of a terminal plate.

FIG. 4 is a cross-sectional view showing a further example of how a conductive wire is bolted to a terminal of a terminal plate.

FIG. 5 is a cross-sectional view showing a further example of how a conductive wire is bolted to a terminal of a terminal plate.

FIG. 6 is a cross-sectional view showing a further example of how a conductive wire is bolted to a terminal of a terminal plate.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

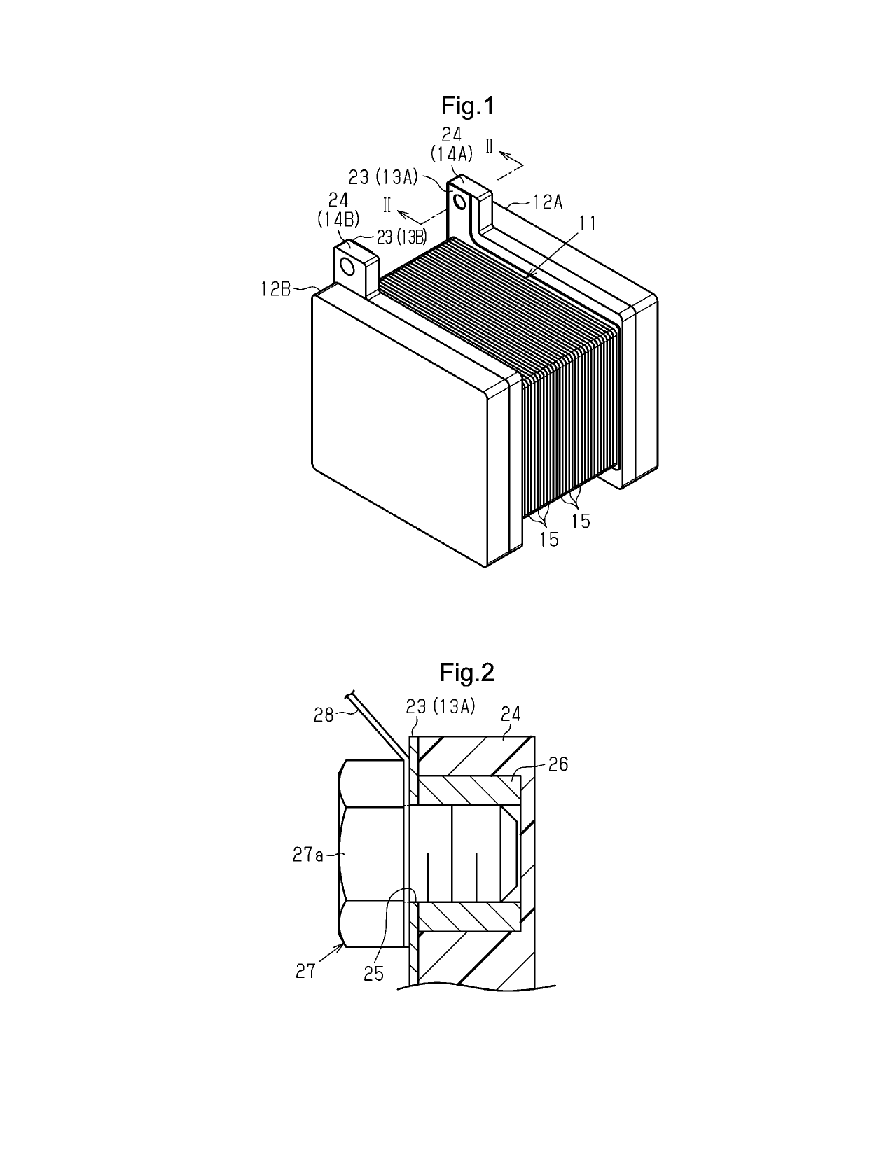

An embodiment of a fuel cell will now be described with reference to FIGS. 1 and 2.

The fuel cell shown in FIG. 1 includes a cell stack 11, a first end plate 12A, a second end plate 12B, a first terminal plate 13A, a second terminal plate 13B, a first insulating plate 14A, and a second insulating plate 14B.

The cell stack 11 is formed by stacking the unit cells 15 in the thickness direction. The first end plate 12A is arranged on a first end of the cell stack 11 in the stacking direction of the unit cells 15. The second end plate 12B is arranged on a second end of the cell stack 11 in the stacking direction of the unit cells 15. The first terminal plate 13A is arranged between the first end plate 12A and the first end of the cell stack 11. The second terminal plate 13B is arranged between the second end plate 12B and the second end of the cell stack 11. The first insulating plate 14A is arranged between the first terminal plate 13A and the first end plate 12A. The second insulating plate 14B is arranged between the second terminal plate 13B and the second end plate 12B. The first end plate 12A, the first terminal plate 13A, and the first insulating plate 14A are stacked in the thickness direction. The second end plate 12B, the second terminal plate 13B, and the second insulating plate 14B are stacked in the thickness direction.

Fuel gas such as hydrogen, oxidant gas such as air, and cooling medium such as coolant flow through the cell stack 11. Each unit cell 15 of the cell stack 11 includes a membrane electrode gas diffusion layer assembly. In the unit cell 15, the fuel gas flows along an anode side of the membrane electrode gas diffusion layer assembly, and the oxidation gas flows along a cathode side of the membrane electrode gas diffusion layer assembly. Further, electric power is generated from the reaction between the fuel gas and the oxidant gas in the membrane electrode gas diffusion layer assembly. The cooling medium flows between the unit cells 15 to cool the unit cells 15 that generate heat when generating electric power.

The terminal plates 13A and 13B, which are configured to collect current from the unit cells 15 of the cell stack 11, are formed from conductive material such as metal. The terminal plates 13A and 13B each include a terminal 23 that projects outward, or upward as viewed in FIG. 1, from an outer edge of the terminal plate. The first insulating plate 14A is configured to insulate the first terminal plate 13A and the first end plate 12A. The second insulating plate 14B is configured to insulate the second terminal plate 13B and the second end plate 12B. The insulating plates 14A and 14B are each formed from insulative material such as resin. Further, a support 24 projects from the outer edge of each of the insulating plates 14A and 14B and extends along one side of the corresponding terminal 23 with respect to the thickness direction. The support 24 projects outward, or upward as viewed in FIG. 1, from the outer edge of each of the insulating plates 14A and 14B.

As shown in FIG. 2, a conductive wire 28, which is configured to transfer electric power from the cell stack 11, is bolted to the terminal 23. The structure bolting the conductive wire 28 to the terminal 23 will now be described in detail. FIG. 2 shows the structure bolting the conductive wire 28 to the terminal 23 of the first terminal plate 13A. The structure is identical to the structure bolting the conductive wire 28 to the terminal 23 of the second terminal plate 13B. Therefore, the structure bolting the conductive wire 28 to the terminal 23 of the second terminal plate 13B will not be described.

As shown in FIG. 2, a through hole 25 extends through the terminal 23 in the thickness direction. The support 24 of the first insulating plate 14A is arranged on a first side of the terminal 23 with respect to the thickness direction; that is, on the right side of the terminal 23 as viewed in FIG. 2. A threaded insert 26, which is for fastening a bolt, is embedded in the support 24. The threaded insert 26 is located at a position corresponding to the through hole 25 of the terminal 23. The threaded insert 26 is in contact with first side of the terminal 23.

A bolt 27 is inserted through the through hole 25 of the terminal 23. The bolt 27 extends through the through hole 25 from a second side of the terminal 23, which is opposite the first side, and is fastened to the threaded insert 26. The bolt 27 is fastened to the threaded insert 26 in a state in which the conductive wire 28 is arranged between a head 27a of the bolt 27 and the terminal 23. This holds the conductive wire 28 between the head 27a of the bolt 27 and the terminal 23. In this manner, the conductive wire 28 is bolted to the terminal 23.

The operation and advantages of the fuel cell according to the present embodiment will now be described.

(1) Each of the terminal plates 13A and 13B, which collects current from the unit cells 15 of the fuel cell, includes the terminal 23, which projects outward from the outer edge of the terminal plate. Further, the insulating plate 14A (14B), which is arranged between the terminal plate 13A (13B) and the end plate 12A (12B) of the fuel cell, includes the support 24, which projects from the outer edge of the insulating plate and extends along the first side of the terminal 23 with respect to the thickness direction. Accordingly, the first side of the terminal 23 is supported by the support 24. Therefore, even if the terminal plate 13A (13B) and the terminal 23 are reduced in thickness, the support 24 of the insulating plate 14A (14B) will limit deformation of the terminal 23 when the conductive wire 28 is bolted to the terminal 23. This allows the thickness of the insulating plates 14A and 14B to be reduced, which, in turn, reduces the weight of the fuel cell without deforming the terminals 23 when the conductive wire 28 is bolted to the terminals 23.

(2) When bolting the conductive wire 28 to the terminal 23, the bolt 27 is inserted through the terminal 23 and fastened to the threaded insert 26 in a state in which the conductive wire 28 is arranged between the head 27a of the bolt 27 and the terminal 23. This bolts the conductive wire 28 to the terminal 23. The threaded insert 26 is embedded in the support 24 of the insulating plate 14A (14B) in contact with the terminal 23 of the terminal plate 13A (13B). Therefore, the fastening of the bolt has a negligible effect on the support 24 of the insulating plate 14A (14B). This avoids deformation of the terminal 23 or the like.

The above-described embodiment may be modified as follows. The above-described embodiment and the following modifications can be combined as long as the combined modifications remain technically consistent with each other. In the following description, each of the first and second end plates 12A and 12B of the above-described embodiment is simply referred to as an end plate 12, each of the first and second terminal plates 13A and 13B is simply referred to as a terminal plate 13, and each of the first and second insulting plates 14A and 14B is simply referred to as an insulating plate 14.

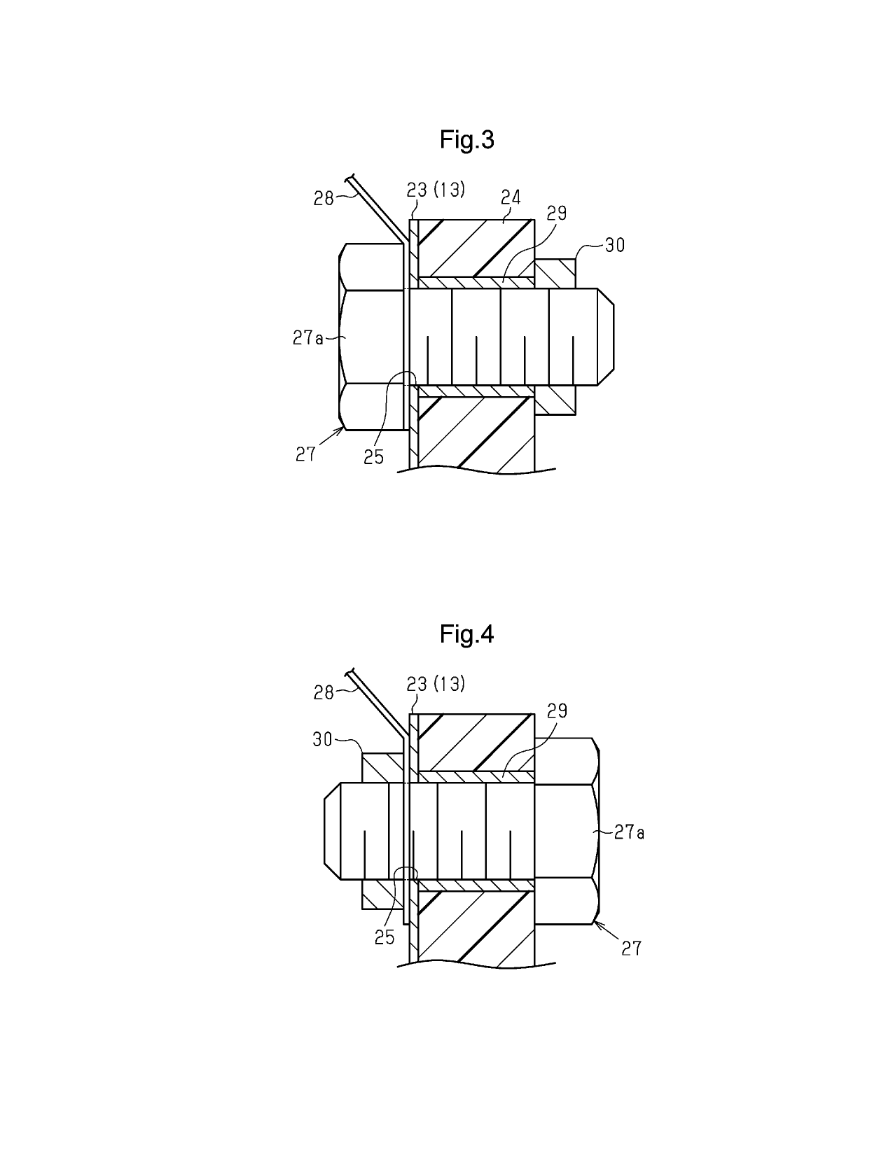

As shown in FIG. 3, instead of embedding the threaded insert 26 in the insulating plate 14, a collar 29 may be embedded in the insulating plate 14 in a manner extending through the support 24 in the thickness direction of the insulating plate 14. Further, after the bolt 27 is inserted through the through hole 25 of the terminal 23 and the collar 29 of the support 24, the bolt 27 may be fastened to a nut 30 that is arranged on the side of the support 24 opposite the terminal 23. In this state, the nut 30 is in contact with the collar 29. Therefore, the support 24 will not be deformed by the fastening of the bolt.

As shown in FIG. 4, the positional relationship between the bolt 27 and the nut 30 in FIG. 3 may be reversed.

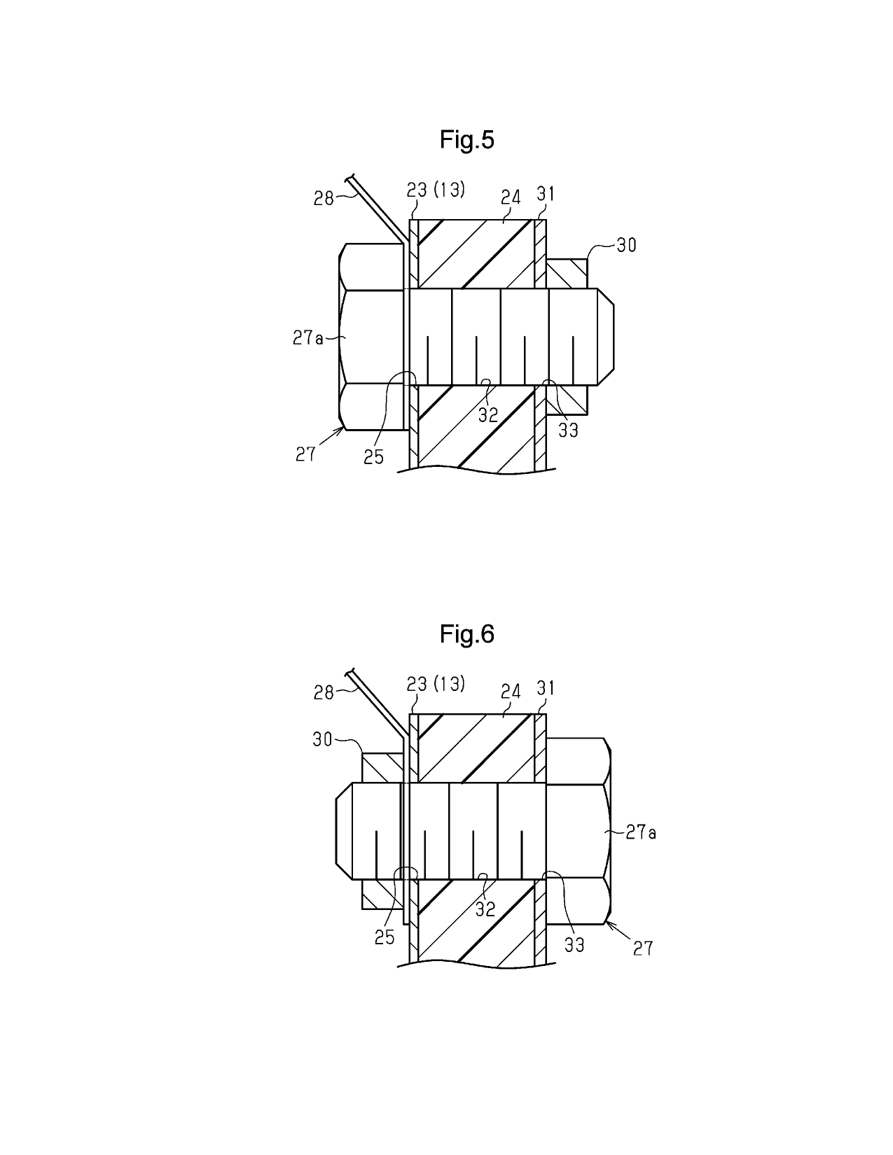

As shown in FIG. 5, instead of embedding the threaded insert 26 in the insulating plate 14, a metal plate 31 may be arranged on the side of the support 24 of the insulating plate 14 opposite the terminal 23. Further, through holes 32 and 33 are respectively formed in the support 24 and the metal plate 31 at positions corresponding to the through hole 25 of the terminal 23. The bolt 27 is inserted through the through hole 25 of the terminal 23, the through hole 32 of the insulating plate 14, and the through hole 33 of the metal plate 31. Then, the bolt 27 is fastened to the nut 30 arranged on the side of the metal plate 31 opposite the support 24. In this state, the nut 30 is in contact with the metal plate 31. Therefore, the support 24 will not be deformed by the fastening of the bolt.

As shown in FIG. 6, the positional relationship between the bolt 27 and the nut 30 in FIG. 5 may be reversed.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A fuel cell, comprising:
a cell stack;
a first end plate;
a second end plate;
a first terminal plate;
a second terminal plate;
a first insulating plate; and
a second insulating plate, wherein
the cell stack is formed by stacking unit cells in a thickness direction,
the first end plate is arranged on a first end of the cell stack in a stacking direction of the unit cells,
the second end plate is arranged on a second end of the cell stack in the stacking direction,
the first terminal plate is arranged between the first end plate and the first end of the cell stack,
the second terminal plate is arranged between the second end plate and the second end of the cell stack,
the first insulating plate is arranged between the first terminal plate and the first end plate,
the second insulating plate is arranged between the second terminal plate and the second end plate,
the first end plate, the first terminal plate, and the first insulating plate are stacked in the thickness direction,
the second end plate, the second terminal plate, and the second insulating plate are stacked in the thickness direction,
the first terminal plate and the second terminal plate each include a terminal that projects outward from its outer edge and allows a conductive wire to be bolted thereto, and
the first insulating plate and the second insulating plate each include a projecting support that extends along one side of the terminal with respect to the thickness direction.

2. The fuel cell according to claim 1, wherein a threaded insert for fastening a bolt is embedded in the support of at least one of the first insulating plate and the second insulating plate.
